(19) United States
(12) Patent Application Publication
(10) Pub. No.: US 2005/0008007 A1
(43) Pub. Date: Jan. 13, 2005

(54) Communication system and method for interconnecting dissimilar wireless radio networks over an IP network

(76) Inventor: Wallace Yang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/902,868

(22) Filed: Aug. 2, 2004

Related U.S. Application Data
(63) Continuation-in-part of application No. 10/033,967, filed on Jan. 3, 2002.

(30) Foreign Application Priority Data
Jan. 20, 2001 (TW) 90201329

(51) Int. Cl. H04L 12/66

(52) U.S. Cl. 370/352; 370/338

(57) ABSTRACT

The present invention provides a communication system and method for interconnecting dissimilar wireless radio networks over an IP network. The communication system comprises an interconnected IP network and a plurality of communication terminals attached to dissimilar wireless radio networks and the IP network. The communication terminals can convert digital signals for dissimilar wireless networks into a digital network signal over IP and vice versa. These digital signals comprise a call control plane and a data plane which can convey voice, video, and other kinds of data. Therefore terminals of the dissimilar wireless radio networks can communicate over the interconnecting IP network of the disclosed communication system.

### REFERENCE TO RELATED APPLICATION

This Patent Application is a Continuation-in-Part of Ser. No. 10/033,967 filed on 3 Jan. 2002, currently pending.

### BACKGROUND OF THE INVENTION

1. FIELD OF THE INVENTION

The present invention generally relates to a communication system and method, and more particularly to a communication system and method for interconnecting dissimilar wireless radio networks over an IP network.

2. DESCRIPTION OF THE PRIOR ART

Wireless communication is getting popular during the last decade. In foreseeable future, wireless communication will even takes more shares in global market. Public mobile services, such as GSM (Global Service for Mobile communication), PHS (Personal Handy-phone System), and 3^{rd} Generation service, are almost a necessary for modern life. Besides, trucked radio, such as TETRA (TErrestial Trunked Radio), also plays an important role in public safety or in private sectors. Besides, traditional RF (Radio Frequency) networks will still operate for a while. Except for those wireless networks operated by commercial operators or public sectors, direct, relayed, and line-of-sight radio systems, such as UHF, VHF, WLAN (Wireless Local Area Network), and WiMax, also incorporate an important part of wireless communication.

All of mentioned wireless communication technologies use different waveforms, frequency window, modulation, and bandwidth. The RF (Radio Frequency) carrier transports analog/digital signals, voice/data traffics, circuit/packet switching schemes. They have various types of user-end equipments, such as mobile handheld set, backpack set, PDA (Personal Digital Assistant), laptop computers, or any other machines. From the perspectives of user, most of these networks transport at least two types of communication, data and audio. In additional to pure data transport, some protocols such as SMS (Simple Message System) and MMS (Multimedia Message System) are built on top of the data transportation layer.

PCM (pulse code modulation) is a digital scheme for transmitting analog data. The signals in PCM are binary; that is, there are only two possible states, represented by logic 1 (high) and logic 0 (low). This is true no matter how complex the analog waveform happens to be. Using PCM, it is possible to digitize all forms of analog data, including full-motion video, voices, music, telemetry, and virtual reality (VR).

For some radio networks, the network terminals expose digital interfaces of PCM, which in turn represents any kinds of digital payload. Please referred to FIG. 1, the PCM protocol is the underlying protocol and it carries digital payloads such as call control signaling and data information. The call control signal is used to set up and tear down calls, carry information required to locate user and negotiate capabilities. For example, DTMF (dual tone multiple frequency) which can be carried by the PCM protocol is one kind of call control signaling. The data information transported by PCM protocol could be voice type, data type, video type, or any other multimedia type of data, even another IP packet embraced in the PCM protocol. The digital interfaces of PCM can transmit and receive the PCM signals; hence the network terminals can be commanded by the call control signaling embraced in the received PCM signals.

Today, IP (Internet Protocol) technology is an emerging and universal telecom and data-com standard. Voice over IP (VOIP) uses the Internet Protocol (IP) to transmit voice as packets over an IP network. So VOIP can be achieved on any data network that uses IP, like Internet, Intranets and Local Area Networks (LAN). Here the voice signal is digitized, compressed and converted to IP packets and then transmitted over the IP network. Signaling protocols are used to set up and tear down calls, carry information required to locate users and negotiate capabilities. Except for the voice signal, the information transported by IP layer could be voice type, data type, video type, or any other multimedia type of data, even another IP packet embraced in the IP protocol. In short, IP packets can categorize into two kinds of planes, a call control plane and a data plane.

Please refer to FIG. 2, which represents the H.323 protocol stack. The audio, video and registration packets use the unreliable User Datagram Protocol (UDP) while the data and control application packets use the reliable Transmission Control Protocol (TCP) as the transport protocol. Both of TCP and UDP are built upon the IP protocol. In short, the H.323 protocol transports a call control plane via TCP and the rest of data plane through UDP.

Summarized the description above, it is desired to develop a system and method to interconnect the wireless networks and the IP networks without modifying any of the existing network.

### SUMMARY OF THE INVENTION

The present invention relates to a communication system and method for interconnecting dissimilar wireless radio networks over an IP network.

One objective of the present invention is to provide an apparatus for converting a digital network signal over IP into a digital signal for wireless network and vice versa. The conversion can be preceded in two planes; one is call control plane, the other is data plane. In this regards, voice, video, and any other data can be conveyed in the data plane. Call setup and other negotiations can be conveyed in the call control plane. More specified, the digital network signal over IP can be the H.323 protocol stack and the digital signal for wireless network can be the PCM signal.

Another objective of the present invention is to provide a communication system and method for interconnecting dissimilar wireless radio networks over an IP network. The communication system comprises an interconnected IP network and a plurality of communication terminals. Each plurality of communication terminals comprises at least a digital wireless network module, a control module, and a network module. Moreover, one kind of PCM digital signal is transmitted and received between the digital wireless network module and the control module. One kind of PCM digital network signal over IP is transmitted and received between the control module and the network module. Each plurality of communication terminals is connected to the IP network via at least a network link. Hence, the kind of PCM digital network signal over IP can be transmitted by the network link, too. The digital wireless network module of each plurality of communication terminals is attached to a wireless network via a RF link. In this regards, the RF link can be utilized at a various part of spectrum, such as HF, VHF, UHF, and etc. Furthermore, the wireless network can be implemented in various standards and technologies, such as GSM, PHS, 3G, TETRA, WLAN, WiMax, and similar trunked radio systems etc. A wireless network terminal is connected to the wireless network via another RF link. Normally, these two RF links may utilize the same spectrum and technology, but it is not required to have this constraint. In addition to voice and voice supplementary services, the wireless network may provide some value-added services, such as SMS, MMS, WAP, and etc. From another perspective, the wireless network may not only be implemented in a sophisticated manner of a trunked radio system, but also a simple relay network or even a direct RF link between the wireless network terminal and the digital wireless network module. Besides, it is not required that the wireless network is “digitalized”. Any kind of wireless networks is applicable to the present invention as long as the digital wireless network module exposes an interface which transmitted a kind of PCM digital signal contains a call control plane and a data plane.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 shows a diagram illustrating a conventional PCM protocol stack;

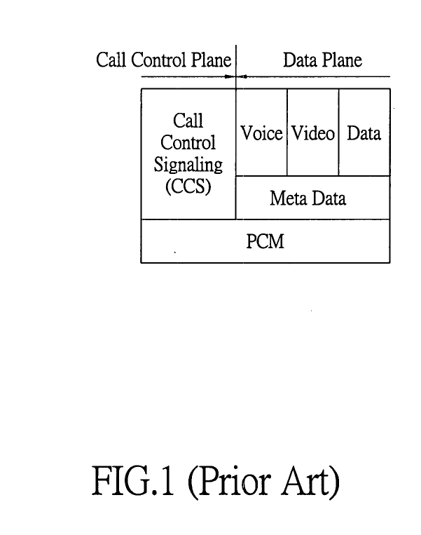

FIG. 2 depicts a diagram illustrating H.323 protocol stack;

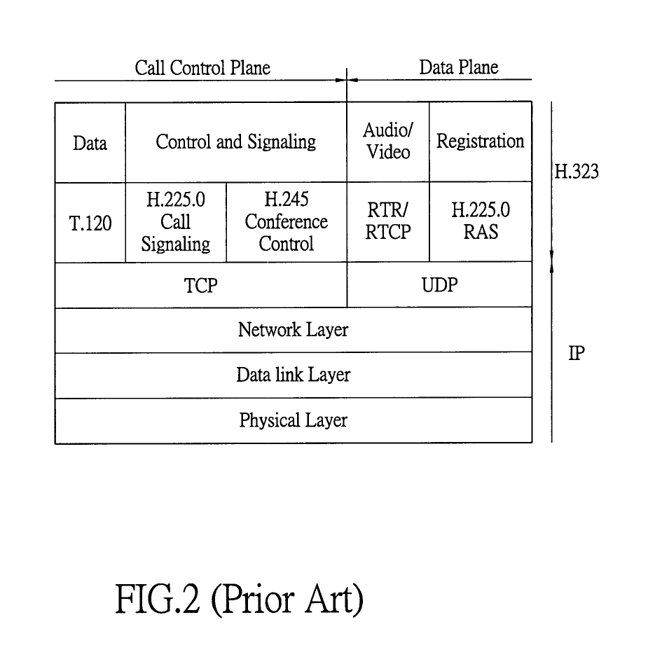

FIG. 3 shows a diagram representing a control apparatus in accordance with an embodiment of the present invention;

FIG. 4 shows a diagram representing a control apparatus in accordance with an embodiment of the present invention;

FIG. 5 shows a diagram representing another control apparatus in accordance with the embodiment of the present invention shown in the FIG. 4;

FIG. 6 shows a communication system in accordance with an embodiment of the present invention; and

FIG. 7 shows a flowchart block diagram of the example in accordance with the embodiment of the present invention shown in the FIG. 6.

### DESCRIPTION OF THE PREFERRED EMBODIMENT(S)

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

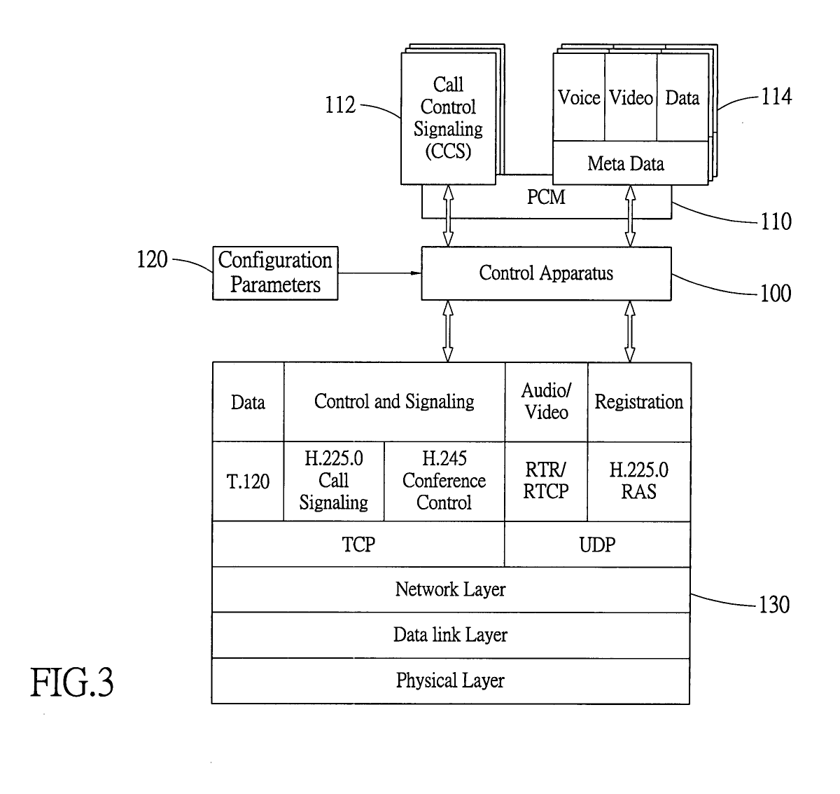

Please refer to FIG. 3, which shows a diagram of a control apparatus 100 in accordance with an embodiment of the present invention. The input of the control apparatus 100 comprises at least a stream of PCM digital signal 110 and a group of configuration parameters 120. The later, the configuration parameters 120, comprises necessary information about the stream of PCM digital signal 110. In this regards, the information comprises a set of CCS (call control signaling) 112 and a set of data 114. Furthermore, the set of data 114 may comprise voice, video, data in other forms, and even the meta-data. For example, a picture can be bundled into the set of data 114, so do multi-media pieces. The output of the control apparatus 100 comprises a stream of H.323 digital signal over IP 130. As described in the prior art, the H.323 digital signal over IP 130 can communicate to any other H.323 compatible apparatus in the interconnecting IP network.

The control apparatus 100 can be implemented in many ways, i.e. in hardware or in software. ASIC (application specified integrated circuit) or FPGA (field programmable gate array) may be the hardware implementation choices of the control apparatus 100. Otherwise, the control apparatus 100 can be a set of programs which are resident on the general purpose computing device to do exactly the same tasks performed by the hardware. In practical, the considerations of implementations are dependent on the cost, the computing performance, the integration issues, or any others. The present invention can apply on the noticed implementation technologies and/or those unmentioned.

A possible voice connection can be set up by the following scenario. At first, a PCM digital signal 110 came in, the control apparatus 100 may consult the group of configuration parameters 120 to translate the CCS 112 contained in the came PCM digital signal 110. For the convenience, in this example, the CCS 112 can be translated a destination code according to configuration parameters 120. Therefore, the control apparatus 100 follows the H.323 standard to set up and negotiate a call through the call control plane. Once the call control plane is built up, the data 114 bundled in the stream of PCM digital signal 110 would be converted by the control apparatus 100 according to the configuration parameters 120 and sent out through the data plane of the H.323 protocol stack. In case the call is hang up or terminated un-intentionally, the control apparatus 100 can detect the event and stop converting the PCM digital signal 110 into the H.323 packets over IP 130. In this regards, the control apparatus 100 may even notify the source of the stream of PCM digital signal 110 to stop sending the stream.

The process mentioned above can be reversed in direction. At first, a series of H.323 packets 130 came in, the control apparatus 100 will realize a H.323 compatible adversary request to set up a call. Therefore, the control apparatus 100 may consult the group of configuration parameters 120 to convert the call control plane of the inbound series of H.323 packets into the CCS 112 of PCM digital signal 110. Once a call is built up, the data plane of the following H.323 packets 130 would be converted into the data 114 of PCM digital signal 110 and sent out. As a result, the PCM digital signal 110 can be converted into the H.323 packets over IP 130 by the control apparatus 100 according to the configuration parameters 120, and vice versa.

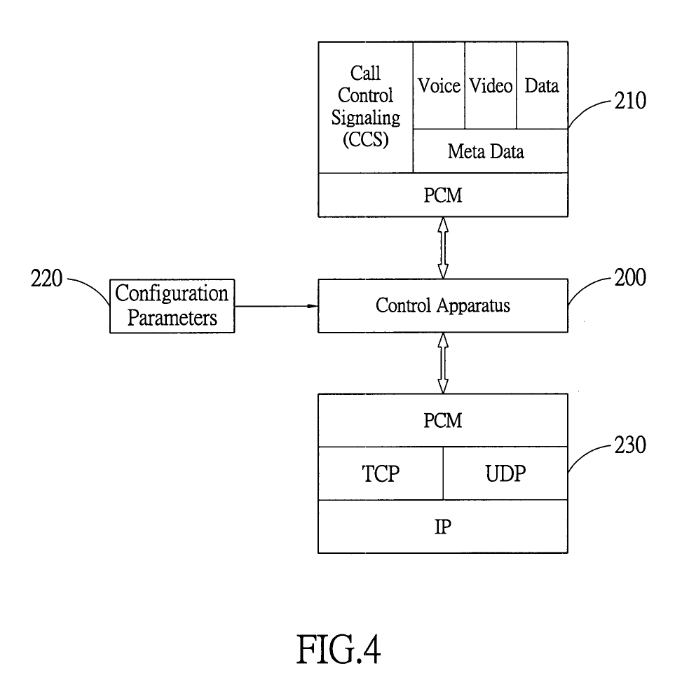

Please refer to FIG. 4, which shows a diagram of a control apparatus 200 in accordance with an embodiment of the present invention. The control apparatus 200 takes a stream of PCM digital signal 210 as the input, and convert into a series of PCM digital signals over IP 230 according to the configuration parameters 220, and vice versa. As described in the embodiment shown in the FIG. 3, the H.323 is one kind of standards of transporting both call control plane and data plane in the interconnecting IP network. In the embodiment shown in the FIG. 4, the control apparatus 200 can convert the PCM digital signal 210 into any other PCM digital signals over IP 230, which also transports both call control plane and data plane in the interconnecting IP network, and vice versa.

The control apparatus 200 can be implemented in many ways, i.e. in hardware or in software. ASIC (application specified integrated circuit) or FPGA (field programmable gate array) may be the hardware implementation choices of the control apparatus 200. Otherwise, the control apparatus 200 can be a set of programs which are resident on the general purpose computing device to do exactly the same tasks performed by the hardware. In practical, the considerations of implementations are dependent on the cost, the computing performance, the integration issues, or any others. The present invention can apply on the noticed implementation technologies and/or those unmentioned.

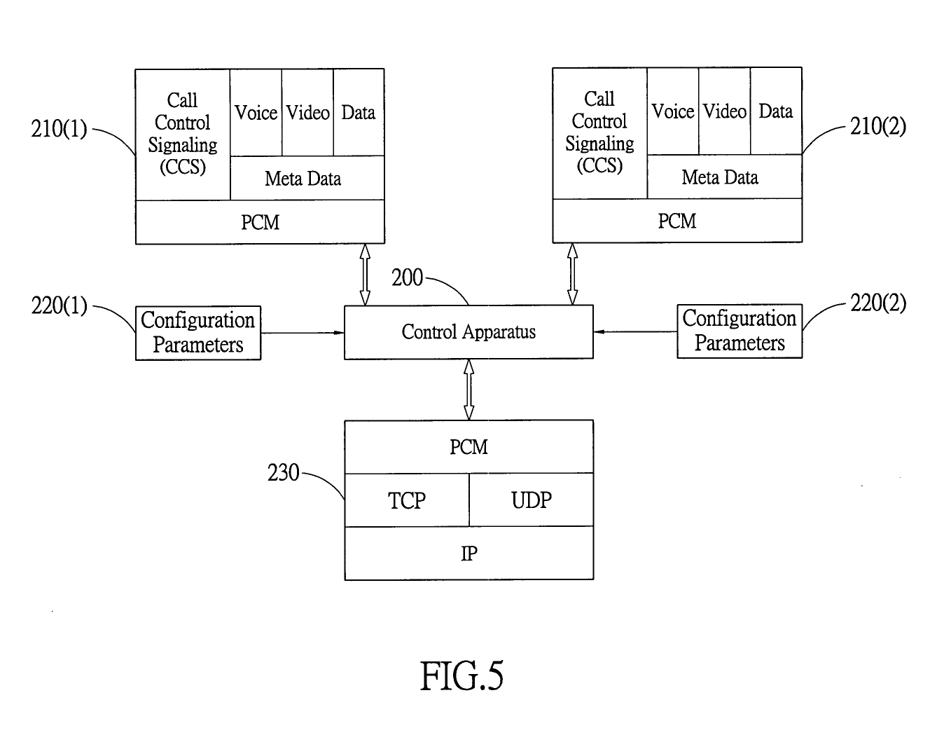

Please refer to FIG. 5, which shows another example in accordance with the embodiment of the present invention. The configuration parameters 220 (1) and 220 (2) are correspondent to the PCM digital signals 210 (1) and 210 (2), respectively. According to the description above, the control apparatus 200 can convert the PCM digital signal 210 (1) into one kind of PCM digital signals over IP 230 and vice versa. Moreover, the PCM digital signal 210 (2) also can be converted into the kind of PCM digital signals over IP 230 and vice versa. Therefore, the control apparatus can convert the PCM digital signals 210 (1) into the PCM digital signals 210 (2) with their respective configuration parameters 220 (1) and 220 (2), and vice versa.

In another example in accordance with the embodiment of the present invention, there is a plurality of PCM digital signals 210 and one kind of PCM digital signal over IP 230 as the input and output of a control apparatus 200. In this regards, each plurality of PCM digital signals 210 owns a corresponding group of configuration parameters 220. The control apparatus 200 can convert each plurality of PCM digital signals 210 into the kind of PCM digital signal over IP 230 according to the correspondent group of configuration parameters 220, and vice versa. In the consequence, the control apparatus 200 can convert each plurality of PCM digital signals 210 into another PCM digital signal 210, and vice versa.

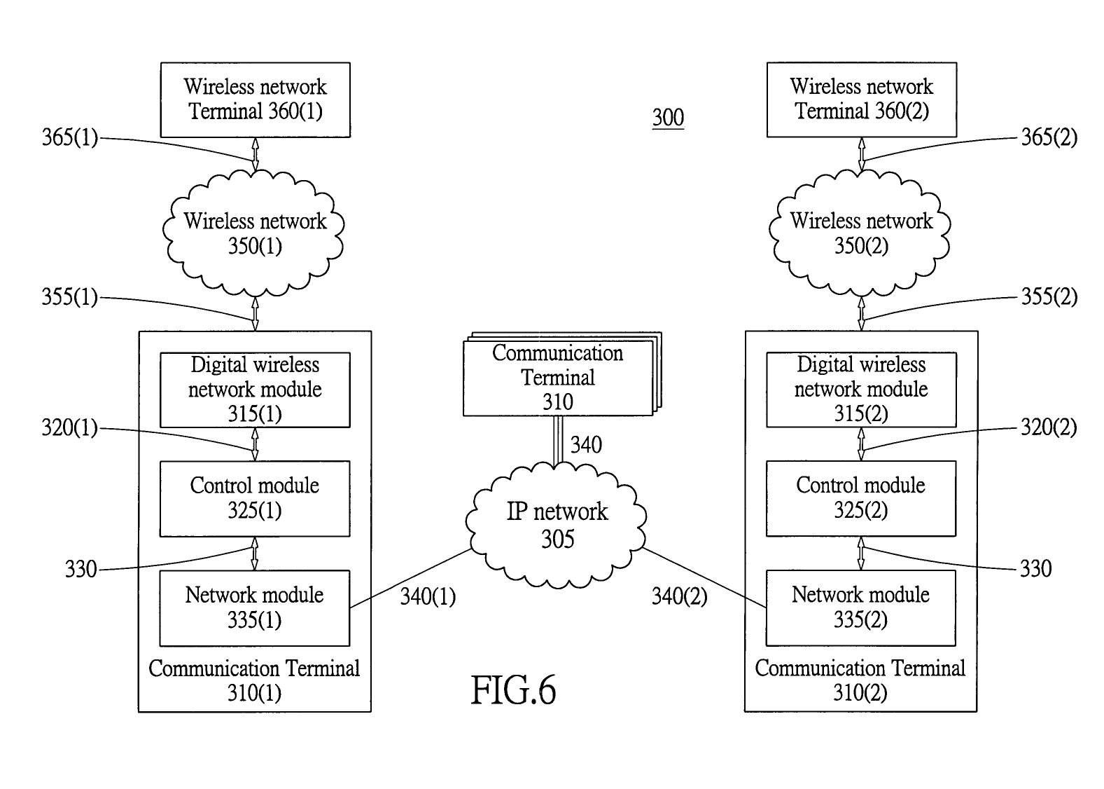

Please refer to FIG. 6, which shows a communication system 300 in accordance with an embodiment of the present invention. The communication system 300 comprises an interconnected IP network 305 and a plurality of communication terminals 310. Each plurality of communication terminals 310 comprises at least a digital wireless network module 315, a control module 325, and a network module 335. Moreover, one kind of PCM digital signal 320 is transmitted and received between the digital wireless network module 315 and the control module 325. One kind of PCM digital network signal over IP 330 is transmitted and received between the control module 325 and the network module 335. Furthermore, the control module 325 comprises a group of configuration parameters (not shown in the FIG. 6) which is corresponding to the kind of PCM digital signal 320.

As shown in FIG. 6, each plurality of communication terminals 310 is connected to the IP network 305 via at least a network link 340. The network link 340 can be implemented in various technologies, such as Ethernet, Token Ring, FDDI, and any other technology, as long as the IP packets can be transported by the network link 340. Hence, the kind of PCM digital network signal over IP 330 can be transmitted by the network link 340, too.

As shown in FIG. 6, the digital wireless network module 315 of each plurality of communication terminals 310 is attached to a wireless network 350 via a RF link 355. In this regards, the RF link 355 can be utilized at a various part of spectrum, such as HF, VHF, UHF, and etc. Furthermore, the wireless network 350 can be implemented in various standards and technologies, such as GSM, PHS, 3G, TETRA, WLAN, WiMax, and similar trunked radio systems etc. A wireless network terminal 360 is connected to the wireless network 350 via another RF link 365. Normally, these two RF links, 355 and 365, may utilize the same spectrum and technology, but it is not required to have this constraint. In addition to voice and voice supplementary services, the wireless network 350 may provide some value-added services, such as SMS, MMS, WAP, and etc. From another perspective, the wireless network 350 may not only be implemented in a sophisticated manner of a trunked radio system, but also a simple relay network or even a direct RF link between the wireless network terminal 360 and the digital wireless network module 315. Besides, it is not required that the wireless network 350 is “digitalized”. Any kind of wireless networks is applicable to the present invention as long as the digital wireless network module exposes an interface which transmitted a kind of PCM digital signal 320 contains a call control plane and a data plane.

The following is an example in accordance with the embodiment of the present invention. The example illustrates that a call initiated by a caller, a first wireless network terminal 360 (1) which attached to a first wireless network 350 (1), is connected to a callee, a second wireless network terminal 360 (2) which attached to a second wireless network 350 (2). In this regards, the caller and the callee attach to different wireless networks.

At first, the caller sets up a first connection between the first wireless network terminal 360 (1) and a first digital wireless network module 315 (1) of a first communication terminal 310 (1) via the first wireless network 350 (1). Once a first control module 325 (1) of the first communication terminal 310 (1) receives a first PCM digital signal 320 (1) from the first digital wireless network module 315 (1), it converts the first PCM digital signal 320 (1) into a PCM digital network signal over IP 330 and transmits through a first network module 335 (1) of the first communication terminal 310 (1). In turn, the PCM digital network signal over IP 330 will transmit to a second communication terminal 310 (2) via the IP network 305 through a first network link 340 (1) of the first communication terminal 310 (1).

In case, the PCM digital network signal over IP 330 is received by a second network module 335 (2) of the second communication terminal 310 (2), a second control module 325 (2) of the second communication terminal 310 (2) will convert it into a second PCM digital signal 320 (2) and transmit to a second digital wireless network module 315 (2). According to the call control plane of the received second PCM digital signal 320 (2), this second digital wireless network module 315 (2) will try to build up a second connection between the second digital wireless network module 315 (2) and the real callee, the second wireless network terminal 360 (2). After the set up of the first connection, the second connection, and an IP connection between these two communication terminals 310 (1) and 310 (2), the caller and the callee can transmit and receive something defined in the data plane.

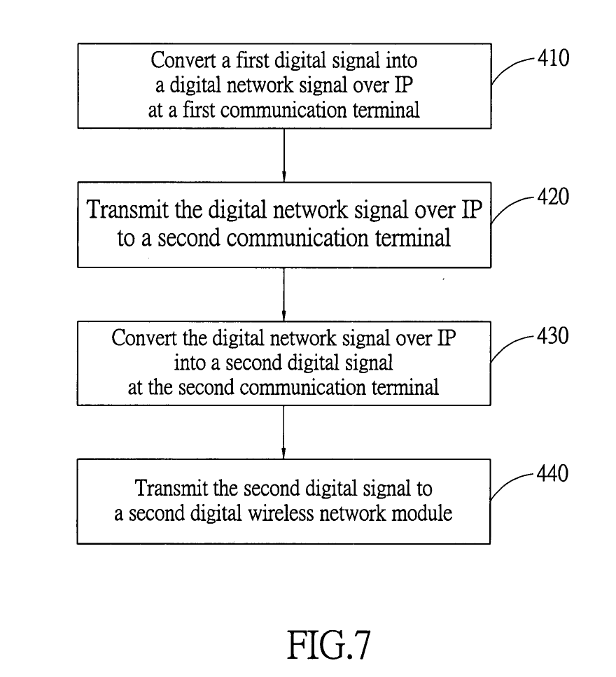

Please refer to FIG. 7, which shows a flowchart block diagram of the example in accordance with the embodiment of the present invention. First, at block 410, the first control module 325 (1) of the first communication terminal 310 (1) converts the first PCM digital signal 320 (1) from the digital wireless network module 315 (1) into the PCM digital network signal over IP 330. Secondly, at block 420, the first control module 325 (1) transmits the PCM digital network signal over IP 330 to the second communication terminal 310 (2) through a route made up by the first network module 335 (1), the first network link 340 (1), the IP network 305, the second network link 340 (2), and the second network module 335 (2). Once the block 420 is done, at block 430, the second control module 325 (2) converts the PCM digital network signal over IP 330 from the second network module 335 (2) into the second PCM digital signal 320 (2). Finally, at block 440, the second control module 325 (2) transmits the converted second PCM digital signal 320 (2) to the second digital wireless network module 315 (2).

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

1. A control apparatus for converting dissimilar digital signals, wherein said control apparatus converts a digital network signal over IP is converted into a digital signal for a wireless network module and vice versa, said digital signal for a wireless network module comprises a PCM (Pulse Code Modulation) signal.

2. The control apparatus of claim 1, wherein said digital network signal over IP further comprises H.323 signal.

3. The control apparatus of claim 1, wherein said PCM signal comprises a video signal.

4. The control apparatus of claim 1, wherein said PCM signal comprises a voice signal.

5. The control apparatus of claim 1, wherein said PCM signal comprises a WAP (Wireless Application Protocol) signal.

6. The control apparatus of claim 1, wherein said PCM signal comprises a SMS (Simple Message System) signal.

7. The control apparatus of claim 1, wherein said PCM signal comprises a MMS (Multi-media Message System) signal.

8. A communication system for interconnecting dissimilar wireless radio networks over an IP network, comprising:
a first communication terminal, comprising:
at least one first digital wireless network module for interconnecting a first external wireless radio network;
a first network module for interconnecting a IP network; and
a first control module for converting a digital network signal over IP to a first digital signal and vice versa, wherein said digital network signal is associated with said first network module and said first digital signal is associated with said first digital wireless network module;
a second communication terminal, comprising:
at least one second digital wireless network module for interconnecting a second external wireless radio network;
a second network module for interconnecting said IP network; and
a second control module for converting said digital network signal over IP to a second digital signal and vice versa, wherein said digital network signal is associated with said second network module and said second digital signal is associated with said second digital wireless network module; and
said IP network for interconnecting said first network module and said second network module.

9. The communication system of claim 8, wherein said digital network signal over IP comprises VoIP (Voice over Internet Protocol) signal.

10. The communication system of claim 8, wherein said first digital signal comprises a PCM (Pulse Code Modulation) signal.

11. The communication system of claim 8, wherein said second digital signal comprises a PCM (Pulse Code Modulation) signal.

12. The communication system of claim 10, wherein said PCM signal comprises a WAP (Wireless Application Protocol) signal.

13. The communication system of claim 10, wherein said PCM signal comprises a SMS (Simple Message System) signal.

14. The communication system of claim 10, wherein said PCM signal comprises a MMS (Multi-media Message System) signal.

15. The communication system of claim 10, wherein said PCM signal comprises a voice signal.

16. The communication system of claim 11, wherein said PCM signal comprises a WAP (Wireless Application Protocol) signal.

17. The communication system of claim 11, wherein said PCM signal comprises a SMS (Simple Message System) signal.

18. The communication system of claim 11, wherein said PCM signal comprises a MMS (Multi-media Message System) signal.

19. The communication system of claim 11, wherein said PCM signal comprises a voice signal.

20. The communication system of claim 8, wherein said first digital wireless network module comprises a GSM (Global Service for Mobile communication) wireless network module.

21. The communication system of claim 8, wherein said first digital wireless network module comprises a PHS (Personal Handy-phone System) wireless network module.

22. The communication system of claim 8, wherein said first digital wireless network module comprises a Third Generation wireless network module.

23. The communication system of claim 8, wherein said first digital wireless network module comprises a TETRA (TErrestial Trunked Radio) wireless network module.

24. The communication system of claim 8, wherein said first digital wireless network module comprises a VHF wireless network module.

25. The communication system of claim 8, wherein said first digital wireless network module comprises an UHF wireless network module.

26. The communication system of claim 8, wherein said second digital wireless network module comprises a GSM (Global Service for Mobile communication) wireless network module.

27. The communication system of claim 8, wherein said second digital wireless network module comprises a PHS (Personal Handy-phone System) wireless network module.

28. The communication system of claim 8, wherein said second digital wireless network module comprises a Third Generation wireless network module.

29. The communication system of claim 8, wherein said second digital wireless network module comprises a TETRA (TErrestial Trunked Radio) wireless network module.

30. The communication system of claim 8, wherein said second digital wireless network module comprises a VHF wireless network module.

31. The communication system of claim 8, wherein said second digital wireless network module comprises an UHF wireless network module.

32. A method for interconnecting dissimilar wireless networks over an IP network, comprising:
converting a first digital signal from a first digital wireless network module at a first communication terminal into a digital network signal over IP;
transmitting said digital network signal over IP to a second communication terminal;
converting said digital network signal over IP into a second digital signal at said second communication terminal; and
transmitting said second digital signal to a second digital wireless network module at said second communication terminal.

33. The method of claim 32, wherein said digital network signal over IP comprises VoIP (Voice over Internet Protocol) signal.

34. The communication system of claim 32, wherein said first digital signal comprises a PCM (Pulse Code Modulation) signal.

35. The communication system of claim 32, wherein said second digital signal comprises a PCM (Pulse Code Modulation) signal.
